(19) United States
(12) Patent Application Publication
(10) Pub. No.: US 2014/0059452 A1
(43) Pub. Date: Feb. 27, 2014

(54) CUMULATIVE ENCYCLOPEDIA METHOD,SYSTEM AND DEVICE

(71) Applicant: Chia Lung Kao, Dublin, CA (US)

(72) Inventor: Chia Lung Kao, Dublin, CA (US)

(21) Appl. No.: 13/975,027

(22) Filed: Aug. 23, 2013

Related U.S. Application Data
(60) Provisional application No. 61/693,201, filed on Aug. 24, 2012.

(51) Int. Cl. H04L 29/06

(52) U.S. Cl. CPC H04L 65/403
USPC 715/753

(57) ABSTRACT

A cumulative encyclopedia comprising a user interface, the user interface configured to provide one or more topics (e.g. information on subjects contained within the cumulative encyclopedia) that are able to be contributed to by one or more users or accounts using the user interface. The contributions are able to comprise any information (e.g. text, images, links, audio, video) that a user or account wishes to add to one or more of the topics. In some embodiments, the contributions are not able to be edited by anyone other than the user or account who added the contribution.

### RELATED APPLICATION(S)

This application claims priority under 35 U.S.C. §119(e) of the co-pending, co-owned U.S. Provisional Patent Application Ser. No. 61/693,201, filed Aug. 24, 2012, and entitled, “CUMULATIVE ENCYCLOPEDIA INTERFACE.” The Provisional Patent Application Ser. No. 61/693,201, filed Aug. 24, 2012, and entitled, “CUMULATIVE ENCYCLOPEDIA INTERFACE” is also hereby incorporated by reference in its entirety.

### FIELD OF THE INVENTION

The present invention relates to the field of encyclopedias. More specifically, the present invention relates to a system, method and device for providing a cumulative encyclopedia.

### BACKGROUND OF THE INVENTION

Merriam-Webster defines an encyclopedia as a work that contains information on all branches of knowledge or treats comprehensively a particular branch of knowledge usually in articles arranged alphabetically often by subject. Currently, encyclopedias have four basic characteristics:

1. Their purpose is to make accumulated knowledge of various topics accessible to a broad audience.
2. They can cover general knowledge or a particular area of knowledge.
3. They use a system of organization. Traditionally, this has been alphabetical, but electronic encyclopedias enable more types of organization and searching as well.
4. Their articles are generally longer than a dictionary's.
Wikipedia is an online encyclopedia that covers topics that traditional printed encyclopedias do not and cannot. There are, however, some problems with using Wikipedia as a single source of topical information. There is a proliferation of information types now available about any topic. Wikipedia currently covers factual, textual information and some images, but there are many other types of topical information that Wikipedia does not cover and users must use other sources to find information.

Because Wikipedia adheres to the traditional, monolithic version of the truth that is supposed to be neutral, controversial topics can become battlegrounds as opposing sides battle over edits. Wikipedia is also susceptible to vandalism because there is only a single version at a time so a vandal can cast doubt on the whole with a single edit. Further, while Wikipedia has greatly expanded the number of contributors of knowledge over the previous generation of paid encyclopedias, it is still only a small fraction of the overall possible pool of contributors. Additionally, the editors of Wikipedia are able to be anonymous which creates credibility problems as to whether they are qualified to edit the pages. Moreover, beyond the cross-linking of factual information within Wikipedia pages, there is no understanding of relationships between topics. For example, people who love the Harry Potter series probably also like the Lord of the Rings trilogy, but there is no direct relationship between the two indicated by Wikipedia.

### SUMMARY OF THE INVENTION

A cumulative encyclopedia that comprises a user interface, the user interface configured to provide one or more topics (e.g. information on subjects contained within the cumulative encyclopedia) that are able to be contributed to by one or more users or accounts using the user interface. The contributions are able to comprise any information (e.g. text, images, links, audio, video . . . ) that a user or account wishes to add to one or more of the topics. In some embodiments, the contributions are not able to be edited by anyone other than the user or account who added the contribution.

A first aspect of the present application is directed to a non-transitory computer readable medium storing a cumulative encyclopedia. The cumulative encyclopedia comprises a topic database having one or more topic entries each including one or more contributions comprising user-contributed information related to the topic and a user interface comprising a contribution module that enables a user to add a contribution to one of the topic entries of the topic database and a display module that displays one of the topic entries upon selection of the topic entry by the user, wherein the display module adjusts how the contributions of the topic entry are displayed on the user interface based on user ratings of the contributions, wherein the topic database is organized in a canonical structure by topic. In some embodiments, the display module adjusts how the contributions of the topic entry are displayed on the user interface by only displaying a subset containing the highest rated contributions for each topic entry. In some embodiments, the user interface further comprises a search module that enables the user to search the topic database based on a query and returns a list of one or more topic entries related to the user query. The cumulative encyclopedia further comprises an account database having one or more user accounts, wherein the contribution module requires the user to be associated with one of the user accounts to add a contribution. In some embodiments, the contribution module only allows the user associated with the user account who added a contribution to subsequently edit the contribution. In some embodiments, the display module displays links to one or more of the topic entries that are related to the selected topic entry while displaying the selected topic entry. In some embodiments, the identity of the user who added each contribution is displayed with the contribution by the display module. In some embodiments, one or more of the contributions comprise at least one of the group consisting of video, audio, graphics and hyperlinks submitted by the user.

A second aspect of the present application is directed to a cumulative encyclopedia system. The system comprises one or more computing devices and one or more servers coupled with the computing devices over a network, wherein together the computing devices and the servers store a topic database having one or more topic entries each including one or more contributions comprising user-contributed information related to the topic and a user interface comprising a contribution module that enables a user to add a contribution to one of the topic entries of the topic database and a display module that displays one of the topic entries upon selection of the topic entry by the user, wherein the display module adjusts how the contributions of the topic entry are displayed on the user interface based on user ratings of the contributions, wherein the topic database is organized in a canonical structure by topic. In some embodiments, the display module adjusts how the contributions of the topic entry are displayed on the user interface by only displaying a subset containing the highest rated contributions for each topic entry. In some embodiments, the user interface further comprises a search module that enables the user to search the topic database based on a query and returns a list of one or more topic entries related to the user query. In some embodiments, the user interface further comprises an account database having one or more user accounts, wherein the contribution module requires the user to be associated with one of the user accounts to add a contribution. In some embodiments, the contribution module only allows the user associated with the user account who added a contribution to subsequently edit the contribution. In some embodiments, the display module displays links to one or more of the topic entries that are related to the selected topic entry while displaying the selected topic entry. In some embodiments, the identity of the user who added each contribution is displayed with the contribution by the display module. In some embodiments, one or more of the contributions comprise at least one of the group consisting of video, audio, graphics and hyperlinks submitted by the user.

A third aspect of the present application is directed to a method of providing a cumulative encyclopedia. The method comprises maintaining a topic database having one or more topic entries on one or more computing devices, wherein each of the topic entries include one or more contributions comprising user-contributed information related to the topic and providing a user interface with at least one of the computing devices, wherein the user interface comprises a contribution module that enables a user to add a contribution to one of the topic entries of the topic database and a display module that displays one of the topic entries upon selection of the topic entry by the user, wherein the display module adjusts how the contributions of the topic entry are displayed on the user interface based on user ratings of the contributions, wherein the topic database is organized in a canonical structure by topic. In some embodiments, the display module adjusts how the contributions of the topic entry are displayed on the user interface by only displaying a subset containing the highest rated contributions for each topic entry. In some embodiments, the user interface further comprises a search module that enables the user to search the topic database based on a query and returns a list of one or more topic entries related to the user query. In some embodiments, the user interface further comprises an account database having one or more user accounts, wherein the contribution module requires the user to be associated with one of the user accounts to add a contribution. In some embodiments, the contribution module only allows the user associated with the user account who added a contribution to subsequently edit the contribution. In some embodiments, the display module displays links to one or more of the topic entries that are related to the selected topic entry while displaying the selected topic entry. In some embodiments, the identity of the user who added each contribution is displayed with the contribution by the display module. In some embodiments, one or more of the contributions comprise at least one of the group consisting of video, audio, graphics and hyperlinks submitted by the user.

### BRIEF DESCRIPTION OF THE DRAWINGS

FIG. 1 illustrates a cumulative encyclopedia system according to some embodiments.

FIG. 2 illustrates a block diagram of an exemplary computing device configured to implement a cumulative encyclopedia system according to some embodiments.

FIG. 3 illustrates a cumulative encyclopedia user interface according to some embodiments.

FIG. 4 illustrates an exemplary cumulative encyclopedia results page including the search module according to some embodiments.

FIG. 5 illustrates an exemplary topic page of topic encyclopedic information according to some embodiments.

FIG. 6 illustrates a flow chart of a method of providing a cumulative encyclopedia according to some embodiments.

### DETAILED DESCRIPTION OF THE PREFERRED EMBODIMENT

Embodiments of a cumulative encyclopedia system are directed to a cumulative encyclopedia comprising a user interface, the user interface configured to provide one or more topics (e.g. information on subjects contained within the cumulative encyclopedia) that are able to be contributed to by one or more users or accounts using the user interface. The contributions are able to comprise any information (e.g. text, images, links, audio, video) that a user or account wishes to add to one or more of the topics. In some embodiments, the contributions are only able to be made by a single person using the user interface and/or the contributions are not able to be edited by anyone other than the user or account who added the contribution. As a result, it provides the advantage of “group think” power with data acquisition and filtering/ranking, while minimizing vandalism and increasing flexibility, growth and linking.

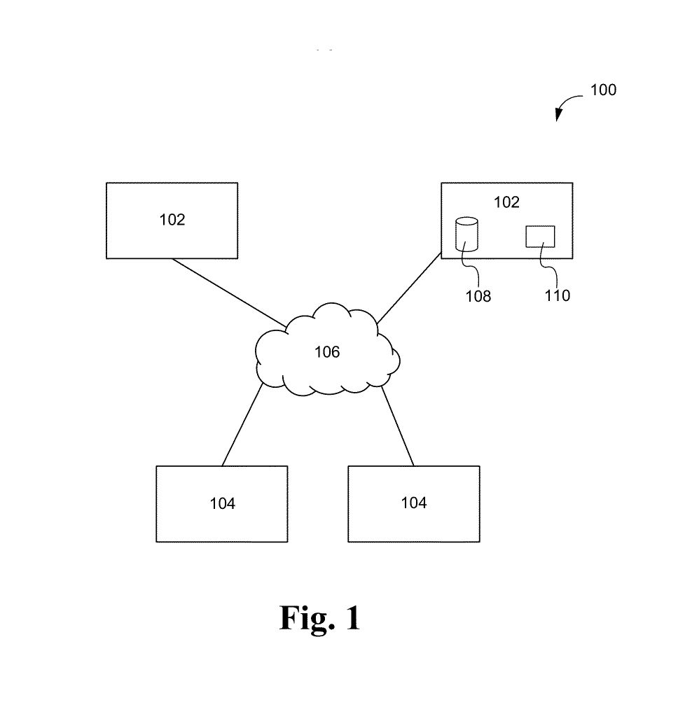

FIG. 1 illustrates a cumulative encyclopedia system 100 according to some embodiments. As shown in FIG. 1, the system 100 comprises one or more servers 102 storing a topic database 108 and a cumulative encyclopedia user interface 110 on a memory and coupled with one or more client devices 104 over one or more networks 106. Although the database 108 and/or user interface 110 are shown stored on the servers 102, one or both of the database 108 and the user interface 110 are able to be stored on a single server 102, a single client device 104, distributed across multiple servers 102, distributed across multiple client device 104, or a combination thereof. The networks 106 are able to be one or a combination of wired or wireless networks as are well known in the art. As a result, a user is able to locally access the system 100 (at least in part) by downloading all or part of the database 108 and/or user interface 110 from the servers 102 to a client device 104 or is able to remotely access the system 100 using browser on the client device 104 that is able to facilitate communication with the database 108 and/or the user interface 110 on the servers 102. In some embodiments, the same/duplicate data related to the database 108 and/or user interface 110 is able to be stored on both the servers 102 and the clients 104 such that either local or remote data access is possible. In such embodiments, some or all of the duplicated data is able to be synchronized across the networks 106. Although as shown in FIG. 1 two servers 102 are coupled with two client devices 104, it is understood that any number of servers 102 are able to be coupled with any number of devices 104.

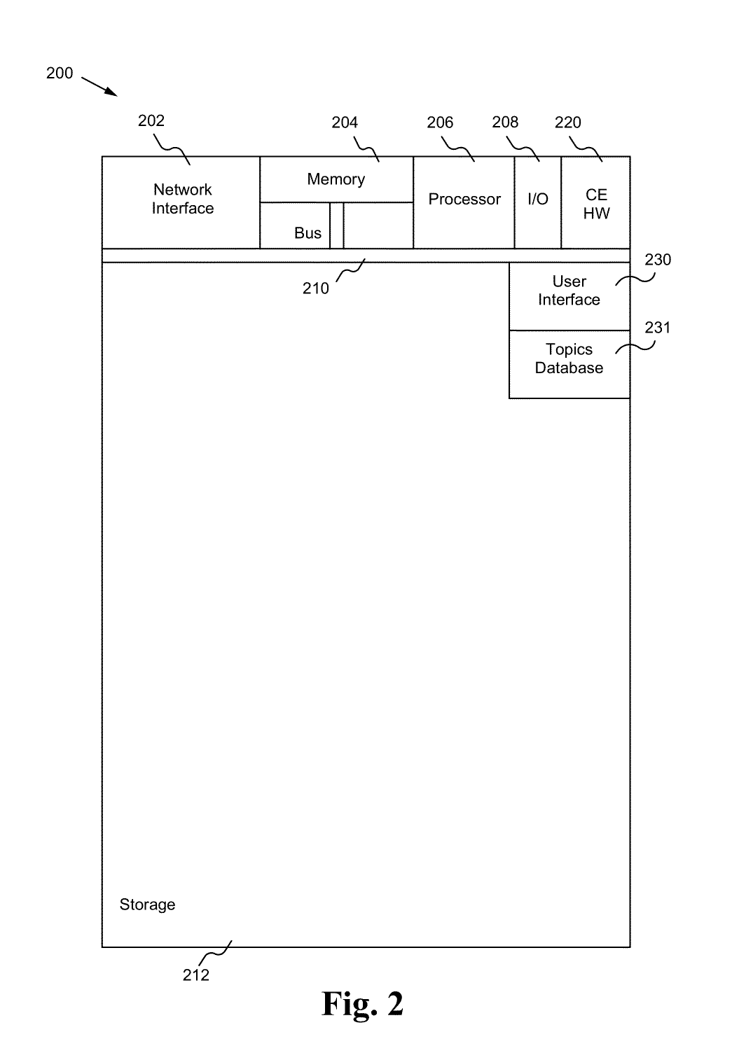

FIG. 2 illustrates a block diagram of an exemplary computing device 200 configured to implement a cumulative encyclopedia system according to some embodiments. The computing device 200 is able to be one or more of the servers 102, one or more of the devices 104 and/or other computing devices that are able to acquire, store, compute, communicate and/or display information such as images and videos. For example, a computing device 200 is able to acquire and store a video. In general, a hardware structure suitable for implementing the computing device 200 includes a network interface 202, a memory 204, a processor 206, I/O device(s) 208, a bus 210 and a storage device 212. Alternatively, one or more of the illustrated components are able to be removed or substituted for other components well known in the art. The choice of processor is not critical as long as a suitable processor with sufficient speed is chosen. The memory 204 is able to be any conventional computer memory known in the art. The storage device 212 is able to include a hard drive, CDROM, CDRW, DVD, DVDRW, flash memory card or any other storage device. The computing device 200 is able to include one or more network interfaces 202. An example of a network interface includes a network card connected to an Ethernet or other type of LAN. The I/O device(s) 208 are able to include one or more of the following: keyboard, mouse, monitor, display, printer, modem, touchscreen, button interface and other devices. Cumulative encyclopedia user interface 230 and/or topics database 231 used to operate the website and/or downloadable application are able to be stored in the storage device 212 and memory 204 and processed as programs are typically processed. More or less components shown in FIG. 2 are able to be included in the computing device 200. In some embodiments, cumulative encyclopedia system hardware 220 is included. The cumulative encyclopedia system 100 is able to be implemented on a computing device in hardware, firmware, software or any combination thereof. Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a Blu-ray® writer/player, a television, a home entertainment system or any other suitable computing device.

The topic database 108 is able to comprise one or more topic entries each directed to different topics and including encyclopedic information about the topic. For example, the encyclopedic information is able to define the topic, provide examples of its uses, provide a history of the topic, provide internal links (e.g. hyperlinks, software buttons) to related topic entries, provide external links to data outside the system 100, provide recommendations of other topic entries (and/or links thereto) and other types of data related to the topic. The encyclopedic information is able to comprise text, video, audio, still images and combinations thereof. The encyclopedic information is able to be user-provided and added to the topic as a user entry such that it is submitted by a user or account holder using the contribution module described below. Alternatively, some or all of the encyclopedic information is able to be administrator-provided such that it is submitted by an administrator of the system 100. In some embodiments, the topics database 108 is organized in a canonical topic structure. For example, each topic is able to have a single dedicated topic page associated with the topic. This provides the advantage of being able to eliminate or not include duplicate/cumulative pages directed toward the same topic. Alternatively, the interface and/or database are able to be organized in a hierarchical tree structure or other types of structures well known in the art.

The cumulative encyclopedia system 100, and in particular, the user interface 110 and/or database 108, are able to be implemented as a downloadable application, an internet accessible website, or both. As a downloadable application, the system 100 is able to be wholly or partially stored on and/or downloadable/uploadable from removable storage (e.g. compact discs, flash drives, or other portable memory) or non-removable storage (e.g. servers, computing devices, or other devices having substantially non portable memory). In some embodiments, a client device 104 is able to access a website providing the database 108 and/or interface 110 and utilize the features of the website with a web browser that communicates with the servers 102 over the networks 106. In some embodiments, the functionality of the website is able to be limited to facilitating the downloading of the application onto one or more client devices 104. For the sake of brevity, the following discussion relates to the functions and operation of system as a website, however it is understood that the discussion is able to also relate to the function and operation of a downloadable application or a combination of website and downloadable application.

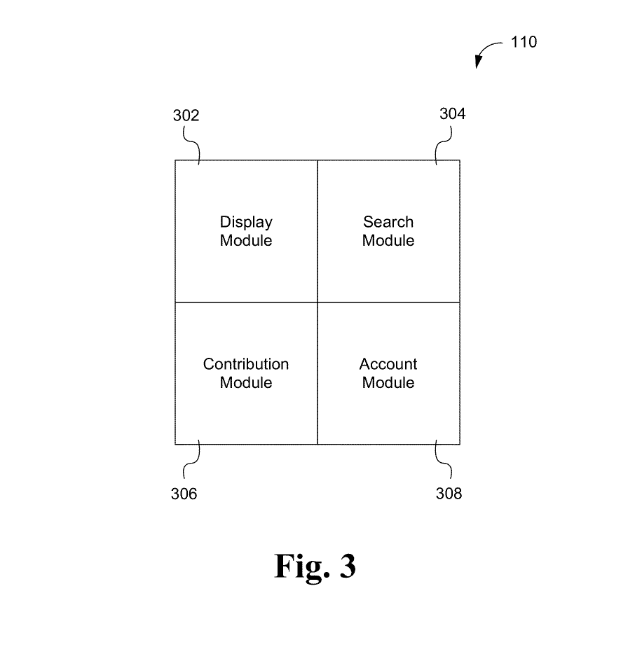

FIG. 3 illustrates a cumulative encyclopedia user interface 110 according to some embodiments. As shown in FIG. 3, the cumulative encyclopedia user interface 110 comprises a display module 302, a search engine module 304, a contribution module 306 and an account module 308. It is understood that the user interface 110 is able to include numerous additional modules for functionality such as install modules, troubleshooting modules and other types of modules well known in the art which have been omitted for the sake of brevity. Alternatively, one or more of the modules are able to be omitted, combined into a single module or separated into multiple modules. The search module 304 enables a user to search for one or more topics within the topic database 108 by entering a query (e.g. keywords) and displaying a results list of the topics within the topic database 108 that are associated with the query.

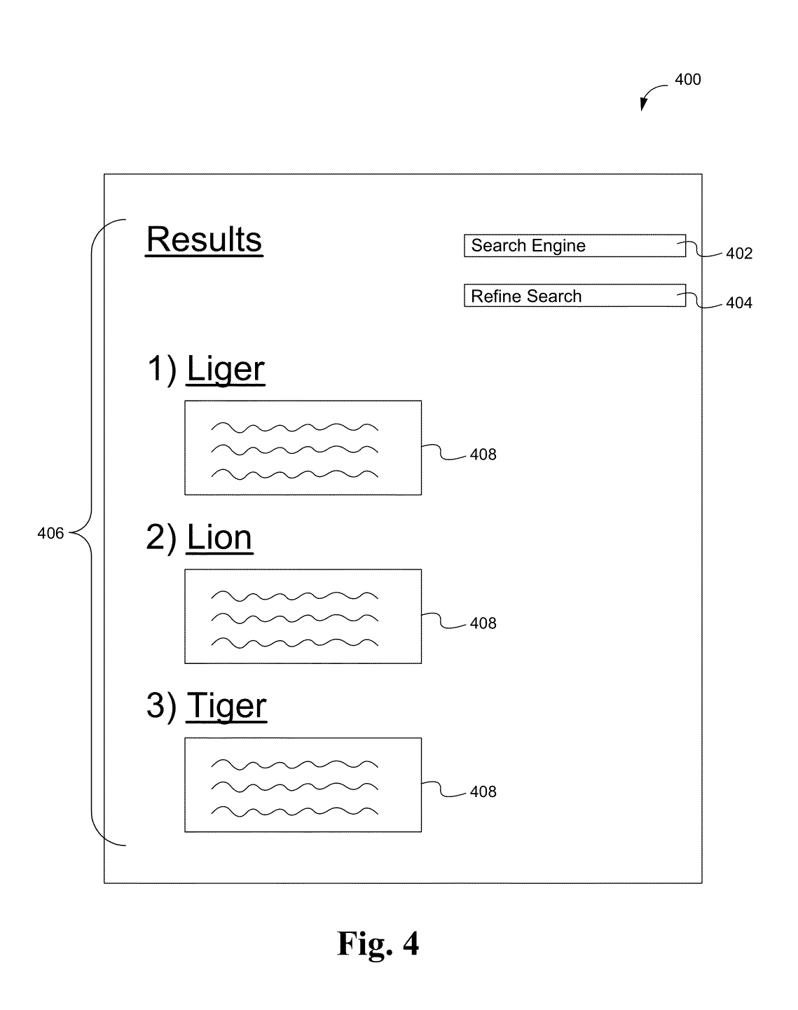

FIG. 4 illustrates an exemplary cumulative encyclopedia results page 400 including the search module 304 according to some embodiments. As shown in FIG. 4, the results page 400 comprises a search engine 402, a refine search feature 404 and a list of results 406. The search engine 402 enables a new search to be made whereas the refine search feature 404 enables a subsequent search from the list of results 406. The results list 406 is able to comprise a preview of the topic page for each of the topics listed in the results list 406. For example, one or more of the user entries 408 (e.g. the highest rated user entries) are able to be shown along with an identifier identifying the topic within the list 406. Each of the topics within the results list 406 are able to be selected which causes the display module 302 to display the topic page(s) associated with the selected topic. In some embodiments, the search module 304 comprises one or more sort/filter features that enable a user to further filter the results list and/or to limit the portion of the database 108 that is initially searched using the query. For example, a results list is able to be refined by a further query and/or the initial data set of the database 108 to be search is able to be limited by one or more characteristics. In some embodiments, the search engine module 304 comprises parametric, dichotomous key, hierarchical tree and/or other types of search mechanisms in addition to the keyword search. The different types of search mechanisms are able to be used individually or in combination.

The display module 302 provides the function of displaying topic encyclopedic information associated with a topic when the topic is selected from the results of the search engine module 304 or other portions of the user interface 110. The displayed topic encyclopedic information is retrieved from the topic information database 108 by the display module 302 and presented as a topic page to a user on the user interface 110. Each of the topic pages comprise one or more user entries/contributions 504 describing the topic that have been added by individual users to the topic encyclopedic information. Alternatively, the topic pages are able to further comprise administer-submitted entries/contributions. In some embodiments, when displaying the user entries 504, the display module 302 displays one or more representations of the rating of the user entry 504.

When displaying the topic information, the display module 302 adjusts the order, position and/or other characteristics of how the user entries 504 are displayed on the user interface 110 based on ratings of the user entries 504. For example, the display module 302 is able to adjust the display of the topic information within the entries 504 based on the ratings of the user entries 504 such that the highest rated entries are highlighted over lower rated user entries. In some embodiments, only a set number of or subset containing the highest rated entries (e.g. the top ten entries) are displayed when displaying the entries 504. In such embodiments, lower rated entries are able to be hidden and inaccessible, hidden but accessible on subsequent pages 500 of the topic, or hidden and deleted. Alternatively, the set number of or subset is able to be replaced with all the entries that exceed a predefined rating (e.g. 8 out of 10), or a combination of the two (e.g. the top ten entries plus any having a rating above a predefined rating). In some embodiments, the position of the entries on the initial topic page are able to adjusted such that the higher or highest rated entries are positioned at the top of the page (e.g. in sequence downward, sideways or otherwise). Additionally, other characteristics of the display of the entries is able to be adjusted such as font type, font size, window size, highlighting, position on the page, background and other display characteristics well known in the art. In some embodiments, the adjustment performed by the display module 302 is based wholly or in part on characteristics of the entries 504 and/or factors other than rating.

In some embodiments, the display module 302 has a sort feature that enables the user to input or select one or more parameters of the user entries 504 (e.g. author, date, rating or other characteristics described herein or well known in the art) that determine (partially or wholly) how the display module 302 adjusts the order, position and/or other characteristics of how the user entries 504 are displayed on the user interface 110 based on ratings of the user entries 504. For example, the user is able to use the sort feature to customize how one or more of the entries 504 on one or more of the topic pages are displayed. Alternatively or in addition, if a user is trying to find a particular entry or entries 504 from a topic page they are able to use the sort feature to search through the entries 504 associated with a topic page in a manner similar to the search module 304 searching for topic pages within the database described herein. In such embodiments, the changes to the display caused by the search are able to be permanent such that subsequent displays of the page will be sorted in the same way, or non-permanent such that a default or customized display of the page is reverted to after the search is finished (e.g. upon subsequent access of the page, upon closing of the search). As a result, the display module 302 enables a user to sort the user entries 504 in order to find a desired entry 504 and/or to customize the display of some or all of the topic pages.

In some embodiments, the display of the entries 504 is adjusted dynamically as the ratings are input. Alternatively, the display of the entries 504 is adjusted periodically, on demand, each time before the entries 504 are displayed and/or at other times or schedules. Some or all of the user entries 504 are able to be indefinitely persistent on the topic page 500 such that their display on the topic page 500 does not expire based on age. For example, the set number of entries, the above the predefined rating entries, or the combination of set number and predefined rating entries are able to persist indefinitely whereas entries that do not meet those criteria for a defined period, fall below a predefined rating threshold, are among a set number of bottom rated entries, or a combination thereof are able to be deleted. As a result, the system 100 provides the advantage of showcasing the most user beneficial (as determined by the ratings) encyclopedic information in the highest rated user entries 504. Thus, the cumulative encyclopedia system 100 not only enables the power of the group think of all users to define a topic, but also uses the same power to filter information so that the most valuable is the easiest to find.

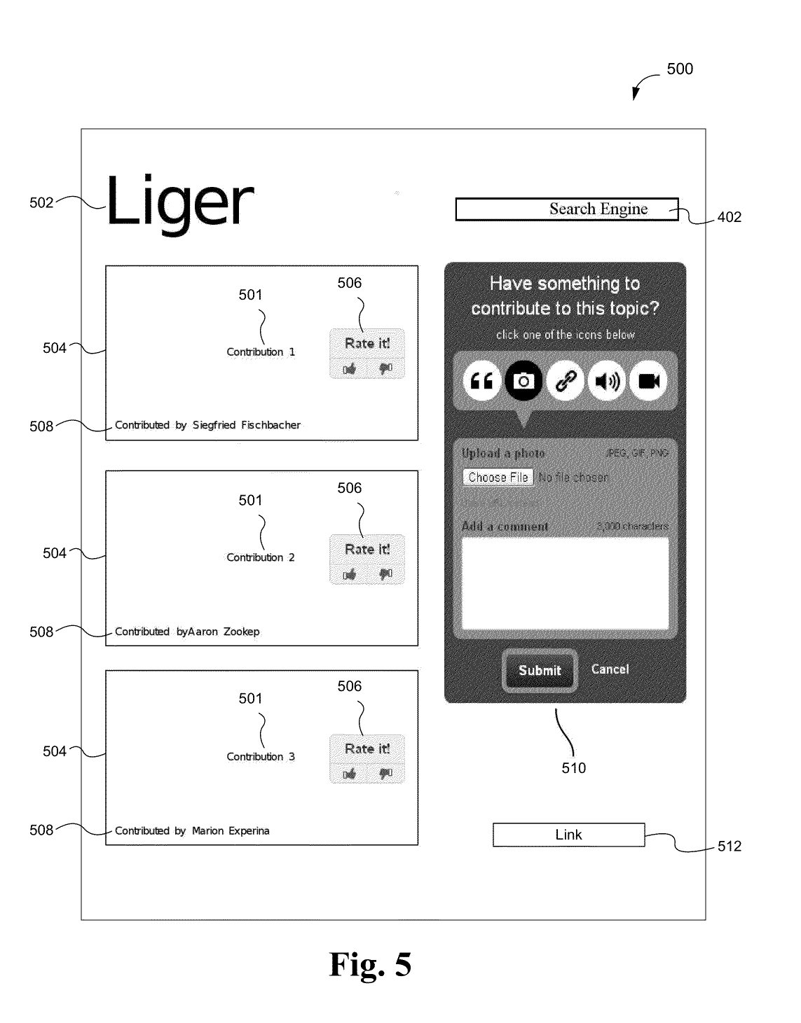

FIG. 5 illustrates an exemplary topic page 500 of topic encyclopedic information according to some embodiments. As shown in FIG. 5, the topic page 500 comprises a title or heading 502 identifying the topic and one or more user entries/contributions 504 associated with the topic. As described above, each of the user entries 504 is able to comprise different formats and types of encyclopedic data 501 about the topic. For example, using the contribution module 306, a user is able to pick not only the types of data (e.g. video, audio, text), but also the format of the data (e.g. font, color, size, volume, speed, autoplay, contrast, saturation) and its positioning/structure as it is displayed within the user entry window. In other words, a user is able to put a video at the top of the user entry followed by text with a playable audio link along the bottom, or any other positioning combination.

As shown in FIG. 5, the user entries 504 are also able to comprise a rating feature 506 and/or a contributor designation 508. The rating feature 506 enables users viewing the user entries 504 to rate the entries 504. The rating feature 506 is able to comprise a “thumbs up” or “thumbs down” binary rating option. Alternatively, the rating feature 506 is able to comprise other types of rating systems such as number (e.g. rating=10), fractional (e.g. 4 out of 5 stars), nominal (e.g. rating=bad, rating=average, rating=good) or combinations thereof. In some embodiments, all users (with or without user accounts) are able to use the rating feature 506 to rate the user entry 504. Alternatively, only users logged into a user account on the system 100 are able to use the rating feature 506 to rate the entry 504. In some embodiments, a user is only able to rate a user entry 504 once. Alternatively, a user is able to rate a user entry 504 multiple times and/or a predefined number of times during a predefined period (e.g. once every month, ten times in a year). In some embodiments, the rating feature 506 shows the current rating of the user entry 504. Alternatively, the rating is able to be hidden. In some embodiments, the user/account that submits an entry 504 is able to submit one or more ratings for the entry 504 that the user submitted. Alternatively, the user/account that submits an entry 504 is not able to submit a rating for the entry 504 that they submitted. In some embodiments, when a user/account is rating an entry 504 the rating feature 506 requests additional information (e.g. identification, age, gender, background, reason for rating, or other user characteristics) be submitted by the user/account along with or in addition to the rating. In some embodiments, when a user/account selects a rating, the rating feature 506 and/or display feature 302 displays a rating history of the entry 504 including some or all the previous ratings of the entry 504. Thus, the system 100 provides the advantage of enabling user's to indicate which contributions 504 they like best as a way of determining the entries 504 with the most value.

The contributor designation 508 comprises identifiers of the authors of the entries 504 such that they enable users to view the creators of the entries 504 in order to evaluate their credibility. In some embodiments, the contributor designations comprise additional data about the contributors such as qualifications regarding the topic (e.g. education, age, number of entries contributed, average rating of contributed entries, employment, work history). In such embodiments, some or all of the additional data is able to be hidden until the contributor designation 508 is selected by a user. The additional data is able to be stored in or based on data associated with the user account of the contributor. As a result, the system 100 provides the benefit of enabling users to judge the credibility of the source of the encyclopedic data and possible factor that judgment into their rating of the user entry 504.

As also shown in FIG. 5, the topic page is able to comprise a submit feature 510 of the contribution module 306 described below, the search engine 402 of the search module 304 and/or one or more links 512. Specifically, the submit feature 510 enables users to upload or create data in order to form a new user entry 504. The submit feature 510 is able to be present on all topic pages 500. Alternatively, the submit feature 510 is able to be displayed on a contribution page not associated with a particular topic in addition to or in lieu of its display on the topic pages 500. In such embodiments, after creation of the user entry 504 from the contribution page, a user is able to select a topic or topic page 500 that the entry 504 is associated with. In some embodiments, this topic selection is able to utilize the search module 304 and/or search engine 402 as described above. The search engine 402 on the topic page 500 enables a user to input a new query and generate a new search results page 400 directly from the current topic page 500. The links 512 are able to be hyperlinks or other types of links that when selected by a user jump to a recommended or associated topic page 500, or to an external location (e.g. external webpage). As shown in FIG. 5, the links 512 are separate from the user entries 504, however one or more of the links 512 are able to be submitted by a user and/or a part of the user entries 504. For example, on a “Liger” topic page, a user is able to create a link to video of a liger or a link to another location. In particular, because the link 512 is able to be user-submitted, the target location does not need to be related to the current topic other than in the opinion of the user. As a result, the system 100 provides the advantage of providing links to recommended other locations independent of whether the other locations have a direct connection to the current topic page enabling connections that would otherwise not be created.

The contribution module 306 along with the account module 308 enables users to create an account on the user interface 110 and utilize the account to contribute to the topic encyclopedic information in the form of user entries 504. Specifically, the user account module 308 enables users to submit user identifying data (e.g. name, username, password, address, phone number, education, employment, age, experience, expertise) in order to create a user account that is then used to identify the user when utilizing the system 100. This user account data is able to be stored in the database 108 as a table of some or all of the user accounts for access by the user interface 110. Alternatively, the user accounts are able to be stored in a separate database. The contribution module 306 enables each account/user to input data using the submit feature 510 in order to create a user entry 504 for each topic that is then able to be added to the topic encyclopedia information of the associated topic page 500. These new user entries 504 are able to be stored in the topic information database 108 and selectively displayed by the display module 302 when it displays the topic pages 500 such that they are able to be rated along with the preexisting user entries 504. As a result, the cumulative encyclopedia user interface 110 provides users with cumulative knowledge about each of the topics in the topic database 108 contributed from different users of the interface 110. These contributions are able to be submitted without rating the topic and/or are able to include as much or as little information as possible in any form (e.g. video, audio, text, images) and organization (e.g. positioning, size, order).

In some embodiments, one or more of the user accounts are able to submit multiple contributions/user entries 504 for each topic 500. Alternatively, each topic or topic page 500 is able to only include one user entry 504 per user/account. In some embodiments, each user entry 504 is only able to be added to the topic page 500 of one topic of the database 108 of topic pages. Alternatively, single user entries 504 are able to be added to multiple different topic pages 500. In some embodiments, only the user/account that created/submitted a contribution 504 is able to edit/delete the user entry 504. This provides the advantage of limiting “vandalism” of a topic by only allowing a single contribution to be “vandalized” instead of the entire topic page. Alternatively, multiple users are able to edit/delete user entries 504 based on assigned privileges. In some embodiments, when new user entries 504 are created, the display module 302 displays the entries 504 on the topic page 500 for a predetermined period and/or until the entries 504 have been rated a predetermined number of times before comparing the entries 504 to the existing entries and applying the display adjustments described above. As a result, the system 100 is able to provide the benefit of enabling new user entries 504 a grace period to obtain an accurate rating before adjusting their display on the page 500. In some embodiments, the topic page 500 has a specified position or window where new entries 504 are positioned until there are deemed to be accurately ranked.

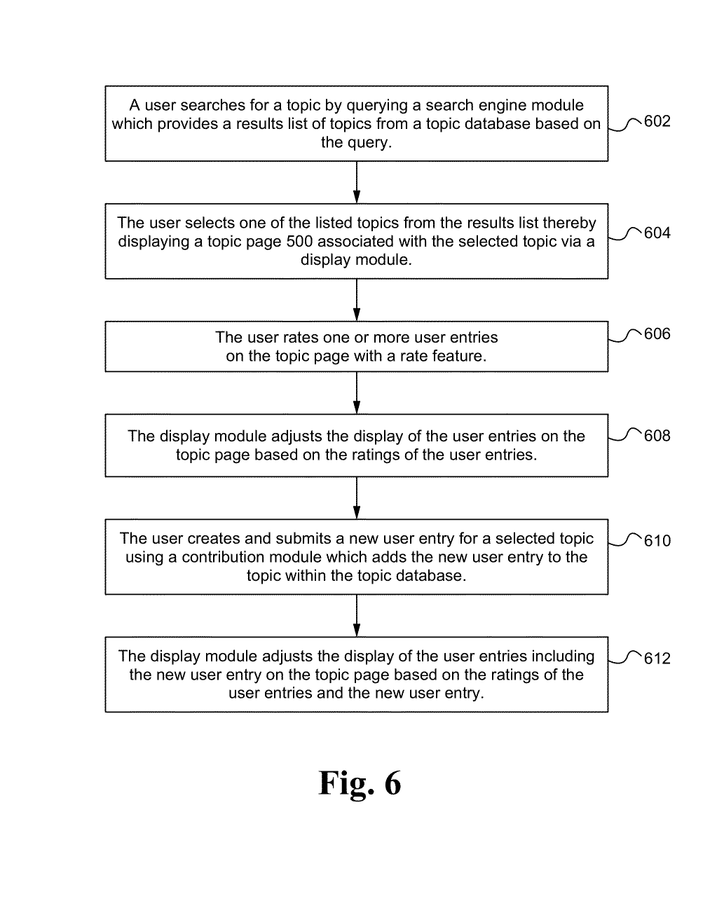

FIG. 6 illustrates a flow chart of a method of providing a cumulative encyclopedia according to some embodiments. As shown in FIG. 6, a user searches for a topic by querying a search engine module 304 which provides a results list of topics from a topic database 108 based on the query at the step 602. The user selects one of the listed topics from the results list thereby displaying a topic page 500 associated with the selected topic via a display module 302 at the step 604. The user rates one or more user entries 504 on the topic page 500 with a rate feature 506 at the step 606. In some embodiments, the user logs onto a user account using a user account module 308 in order to rate the user entries 504. The display module 302 adjusts the display of the user entries 504 on the topic page 500 based on the ratings of the user entries 504 at the step 608. The user creates and submits a new user entry 504 for a selected topic using a contribution module 306 which adds the new user entry 504 to the topic within the topic database 108 at the step 610. In some embodiments, the user logs onto a user account using a user account module 308 in order to create and submit the new user entries 504. The display module 302 adjusts the display of the user entries 504 including the new user entry 504 on the topic page 500 based on the ratings of the user entries 504 and the new user entry 504 at the step 612. In some embodiments, each of one or more topic entries/pages within the topic database 108 include one or more user entries/contributions 504 comprising user-contributed information related to the topic. In some embodiments, the searching, displaying, creating and submitting is enabled via a user interface 110. In some embodiments, the display module 302 adjusts how the user entries 504 of the topic entry are displayed on the user interface 110 by only displaying a set number of the highest rated entries 504 for each topic entry. In some embodiments, the topic database 108 is organized in a canonical structure by topic. In some embodiments, the user interface 110 further comprises an account database having one or more user accounts, wherein the contribution module 306 requires the user to be associated with one of the user accounts to add a new user entry 504. In some embodiments, the contribution module 306 only allows the user associated with the user account who added a user entry 504 to subsequently edit the entry 504. In some embodiments, the contribution module 306 only allows a single entry 504 to be added to each topic entry per user account. In some embodiments, the identity 508 of the user who added each user entry 504 is displayed with the entry 504 by the display module 302. In some embodiments, one or more of the user entries 504 comprise at least one of the group consisting of video, audio, graphics, images and hyperlinks submitted by the user.

The cumulative encyclopedia system, device and method described herein provides the advantages of limiting vandalism of the encyclopedia because, although a single person can create a vandal post, it does not contaminate the whole, only itself. Further, is provides the advantage of providing recommendations linking one topic to another topic beyond mere cross-linking of factual information. Additionally, it provides the advantage of being able to eliminate or not include duplicate/cumulative pages directed toward the same topic due to its canonical structure. Moreover, it provides the advantage of showcasing the most user beneficial (as determined by the ratings) encyclopedic information in the highest rated user entries. Thus, the cumulative encyclopedia system not only enables the power of the group think of all users to define a topic, but also uses the same power to filter information so that the most valuable is the easiest to find. Also, the system provides the advantage of enabling user's to indicate which contributions 504 they like best as a way of determining the entries with the most value. Finally, the system provides the advantage of providing links to recommended other locations independent of whether the other locations have a direct connection to the current topic page enabling connections that would otherwise not be created.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the appended claims. For example, the system 100 is able to further comprise a feedback feature via the user interface 110 that enables users to submit queries or suggestions about data to be added to the topics, wherein the queries are able to be made to an entire topic or to a particular user entry or entries 504 of a topic.

What is claimed is:

1. A non-transitory computer readable medium storing a cumulative encyclopedia, the cumulative encyclopedia comprising:
a topic database having one or more topic entries each including one or more contributions comprising user-contributed information related to the topic; and
a user interface comprising:
a contribution module that enables a user to add a contribution to one of the topic entries of the topic database; and
a display module that displays one of the topic entries upon selection of the topic entry by the user, wherein the display module adjusts how the contributions of the topic entry are displayed on the user interface based on user ratings of the contributions;
wherein the topic database is organized in a canonical structure by topic.

2. The medium of claim 1 wherein the display module adjusts how the contributions of the topic entry are displayed on the user interface by only displaying a subset containing the highest rated contributions for each topic entry.

3. The medium of claim 1 wherein the user interface further comprises a search module that enables the user to search the topic database based on a query and returns a list of one or more topic entries related to the user query.

4. The medium of claim 1 further comprising an account database having one or more user accounts, wherein the contribution module requires the user to be associated with one of the user accounts to add a contribution.

5. The medium of claim 4 wherein the contribution module only allows the user associated with the user account who added a contribution to subsequently edit the contribution.

6. The medium of claim 1 wherein the display module displays links to one or more of the topic entries that are related to the selected topic entry while displaying the selected topic entry.

7. The medium of claim 4 wherein the identity of the user who added each contribution is displayed with the contribution by the display module.

8. The medium of claim 1 wherein one or more of the contributions comprise at least one of the group consisting of video, audio, graphics and hyperlinks submitted by the user.

9. A cumulative encyclopedia system comprising:
one or more computing devices; and
one or more servers coupled with the computing devices over a network, wherein together the computing devices and the servers store:
a topic database having one or more topic entries each including one or more contributions comprising user-contributed information related to the topic; and
a user interface comprising:
a contribution module that enables a user to add a contribution to one of the topic entries of the topic database; and
a display module that displays one of the topic entries upon selection of the topic entry by the user, wherein the display module adjusts how the contributions of the topic entry are displayed on the user interface based on user ratings of the contributions;
wherein the topic database is organized in a canonical structure by topic.

10. The system of claim 9 wherein the display module adjusts how the contributions of the topic entry are displayed on the user interface by only displaying a subset containing the highest rated contributions for each topic entry.

11. The system of claim 9 wherein the user interface further comprises a search module that enables the user to search the topic database based on a query and returns a list of one or more topic entries related to the user query.

12. The system of claim 9 wherein the user interface further comprises an account database having one or more user accounts, wherein the contribution module requires the user to be associated with one of the user accounts to add a contribution.

13. The system of claim 12 wherein the contribution module only allows the user associated with the user account who added a contribution to subsequently edit the contribution.

14. The system of claim 9 wherein the display module displays links to one or more of the topic entries that are related to the selected topic entry while displaying the selected topic entry.

15. The system of claim 12 wherein the identity of the user who added each contribution is displayed with the contribution by the display module.

16. The system of claim 9 wherein one or more of the contributions comprise at least one of the group consisting of video, audio, graphics and hyperlinks submitted by the user.

17. A method of providing a cumulative encyclopedia, the method comprising:
maintaining a topic database having one or more topic entries on one or more computing devices, wherein each of the topic entries include one or more contributions comprising user-contributed information related to the topic; and
providing a user interface with at least one of the computing devices, wherein the user interface comprises:
a contribution module that enables a user to add a contribution to one of the topic entries of the topic database; and
a display module that displays one of the topic entries upon selection of the topic entry by the user, wherein the display module adjusts how the contributions of the topic entry are displayed on the user interface based on user ratings of the contributions;
wherein the topic database is organized in a canonical structure by topic.

18. The method of claim 17 wherein the display module adjusts how the contributions of the topic entry are displayed on the user interface by only displaying a subset containing the highest rated contributions for each topic entry.

19. The method of claim 17 wherein the user interface further comprises a search module that enables the user to search the topic database based on a query and returns a list of one or more topic entries related to the user query.

20. The method of claim 17 wherein the user interface further comprises an account database having one or more user accounts, wherein the contribution module requires the user to be associated with one of the user accounts to add a contribution.

21. The method of claim 20 wherein the contribution module only allows the user associated with the user account who added a contribution to subsequently edit the contribution.

22. The method of claim 17 wherein the display module displays links to one or more of the topic entries that are related to the selected topic entry while displaying the selected topic entry.

23. The method of claim 20 wherein the identity of the user who added each contribution is displayed with the contribution by the display module.

24. The method of claim 17 wherein one or more of the contributions comprise at least one of the group consisting of video, audio, graphics and hyperlinks submitted by the user.
